(19) United States
(12) Patent Application Publication
(10) Pub. No.: US 2025/0061363 A1
(43) Pub. Date: Feb. 20, 2025

(54) SECURE DATA TRANSMISSION USING ENTANGLED QUBITS

(71) Applicant: INTERNATIONAL BUSINESS MACHINES CORPORATION, ARMONK, NY (US)

(72) Inventor: Sriram Lakshmanan, Shrewsbury, MA (US)

(21) Appl. No.: 18/449,341

(22) Filed: Aug. 14, 2023

(51) Int. Cl. G06N 10/40

(52) U.S. Cl. CPC G06N 10/40; H04L 9/40

(57) ABSTRACT

Described are techniques for secure data transmission such as a method including generating a sender binary value by measuring a first qubit associated with a sender device. The first qubit is entangled with a second qubit associated with a receiver device. The method further includes generating a securely transmittable value by providing the sender binary value and a data bit to an XOR gate. The data bit is configured to be derived by the receiver device by supplying the securely transmittable value and a receiver binary value from the second qubit to an XNOR gate.

### BACKGROUND

The present disclosure relates to cybersecurity, and, more specifically, to secure data communication.

Traditionally, data transmission can be performed by a sender encrypting data using an encryption algorithm. The encryption process modifies the contents of the data, and the encrypted data is transmitted over a network to a receiver. The receiver can decrypt the encrypted data using a corresponding decryption algorithm. The security of the encrypted data is based on the strength of the encryption algorithm and the inability of any eavesdropper to decipher the intercepted message in a reasonable amount of time using classical computing.

### SUMMARY

Aspects of the present disclosure are directed toward a system including a first quantum state measurement device configured to generate a sender binary value in response to measuring a first qubit. The system further includes a second quantum state measurement device configured to generate a receiver binary value in response to measuring a second qubit that is entangled with the first qubit. The system further includes a sender device configured to combine the sender binary value and a data bit in an XOR gate to generate a securely transmittable value. The sender device is further configured to transmit the securely transmittable value to a receiver device. The system further includes the receiver device that is configured to combine the receiver binary value and the securely transmittable value in an XNOR gate to generate the data bit.

Additional aspects of the present disclosure are directed toward a computer-implemented method including generating a sender binary value by measuring a first qubit associated with a sender device, where the first qubit is entangled with a second qubit associated with a receiver device. The method further includes generating a securely transmittable value by providing the sender binary value and a data bit to an XOR gate, where the data bit is configured to be derived by the receiver device by supplying the securely transmittable value and a receiver binary value from the second qubit to an XNOR gate.

Additional aspects of the present disclosure are directed toward a method including receiving, at a receiver device, a securely transmittable value from a sender device associated with a first qubit, where the securely transmittable value is configured to securely convey a data bit from the sender device to the receiver device. The method further includes generating a receiver binary value by measuring a second qubit that is entangled with the first qubit. The method further includes generating the data bit by supplying the securely transmittable value and the binary value to an XNOR gate.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example system for secure data transmission using entangled qubits, in accordance with some embodiments of the present disclosure.

FIG. 2 illustrates a data flow diagram within a system for secure data transmission using entangled qubits, in accordance with some embodiments of the present disclosure.

FIG. 3A illustrates a flowchart of an example method for secure data transmission using entangled qubits at a sender device, in accordance with some embodiments of the present disclosure.

FIG. 3B illustrates a flowchart of an example method for secure data transmission using entangled qubits at a receiver device, in accordance with some embodiments of the present disclosure.

FIG. 4A illustrates a flowchart of an example method for utilizing a validation repository by a sender device, in accordance with some embodiments of the present disclosure.

FIG. 4B illustrates a flowchart of an example method for utilizing a validation repository by a receiver device, in accordance with some embodiments of the present disclosure.

FIG. 5 illustrates a flowchart of an example method for downloading, deploying, metering, and billing usage of secure data transmission code, in accordance with some embodiments of the present disclosure.

FIG. 6 illustrates a block diagram of an example computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward secure data communication, and, more specifically, to secure data transmission using entangled qubits. While not limited to such applications, embodiments of the present disclosure may be better understood in light of the aforementioned context.

Various aspects of the present disclosure include, but are not limited to, the following examples. Example 1 is a system 100. The system 100 includes a first quantum state measurement device 110 configured to generate a sender binary value 114 in response to measuring a first qubit 112. The system 100 further includes a second quantum state measurement device 122 configured to generate a receiver binary value 126 in response to measuring a second qubit 124 that is entangled with the first qubit 112. The system 100 further includes a sender device 102 configured to combine the sender binary value 114 and a data bit 104 in an XOR gate 106 to generate a securely transmittable value 108. The sender device 102 is further configured to transmit the securely transmittable value 108 to a receiver device 116. The system 100 further includes the receiver device 116 that is configured to combine the receiver binary value 126 and the securely transmittable value 108 in an XNOR gate 118 to generate the data bit 104.
Advantageously, Example 1 provides a mechanism to securely transmit data using entangled qubits. More specifically, Example 1 provides a mechanism for secure data transmission that does not rely on encryption. By not relying on encryption, the system 100 of Example 1 is resilient to quantum-based decryption attacks. Instead, the system 100 of Example 1 relies on communicating information that is not, itself, the transmitted data while nonetheless enabling the deciphering of the transmitted data using the phenomenon of entanglement between two qubits.
Example 2 includes the features of Example 1. In this example, the sender binary value 114 is opposite the receiver binary value 126. Advantageously, the physics of entanglement can be used to ensure the sender binary value 114 is consistently opposite the receiver binary value 126, thereby creating a secure backchannel by which to transmit information enabling deciphering of the securely transmittable value 108 by the receiver device 116.
Example 3 includes the features of any one of Examples 1 to 2. In this example, the sender binary value 114 has a random probabilistic distribution between 0 and 1. Advantageously, measuring the first qubit 112 causes it to collapse from a state of superposition to a random classical bit. The randomness of the sender binary value 114 makes the securely transmittable value 108 unpredictable and impossible to discern with better than 50% probability by a malicious party.
Example 4 includes the features of any one of Examples 1 to 3. In this example, the securely transmittable value 108 does not contain the data bit 104. As a result, if the securely transmittable value 108 is maliciously intercepted, it cannot be decrypted (e.g., using advanced technologies such as supercomputing or quantum computing).
Example 5 includes the features of any one of Examples 1 to 4. In this example, the system 100 further includes a validation repository 128 accessible by the sender device 102 and the receiver device 116. Further, the validation repository 128 stores validation qubit identifiers 130 and a subset of sender binary values 132. Additionally, the receiver device 116 is configured to compare the subset of sender binary values 132 to receiver binary values of a subset of a plurality of receiver qubits 123 with positions corresponding to the validation qubit identifiers 130 to verify an integrity of a communication channel between the sender device 102 and the receiver device 116. Advantageously, the validation repository 128 provides a mechanism to verify the integrity of the communication channel between the sender device 102 and the receiver device 116 by determining if the subset of sender binary values 132 is opposite the subset of receiver binary values for corresponding pairs of entangled qubits identified in the validation qubit identifiers 130.
Example 6 is a computer-implemented method. The method includes generating a sender binary value 114 by measuring a first qubit 112 associated with a sender device 102, where the first qubit 112 is entangled with a second qubit 124 associated with a receiver device 116. The method further includes generating a securely transmittable value 108 by providing the sender binary value 114 and a data bit 104 to an XOR gate 106, where the data bit 104 is configured to be derived by the receiver device 116 by supplying the securely transmittable value 108 and a receiver binary value 126 from the second qubit 124 to an XNOR gate 118.

Advantageously, Example 6 provides a mechanism to securely transmit data using entangled qubits. More specifically, Example 6 provides a mechanism for secure data transmission that does not rely on encryption. By not relying on encryption, Example 6 is resilient to quantum-based decryption attacks. Instead, Example 6 relies on communicating information that is not, itself, the transmitted data while nonetheless enabling the deciphering of the transmitted data using the phenomenon of entanglement between two qubits.
Example 7 includes the features of Example 6. In this example, the method further includes transmitting the securely transmittable value 108 to the receiver device 116 via a network 120. Advantageously, the securely transmittable value 108 can be transmitted via a public and/or unsecured network 120 insofar as the data bit 104 cannot be derived from the securely transmittable value 108 without knowledge of sender binary value 114 or receiver binary value 126.
Example 8 includes the features of any one of Examples 6 to 7. In this example, the receiver binary value 126 is an opposite of the sender binary value 114. Advantageously, the physics of entanglement can be used to ensure the sender binary value 114 is consistently opposite the receiver binary value 126, thereby creating a secure backchannel by which to transmit information enabling deciphering of the securely transmittable value 108 by the receiver device 116.
Example 9 includes the features of any one of Examples 6 to 8. In this example, the method further includes publishing, by the sender device 102, validation qubit identifiers 130 and a subset of sender binary values 132 to a validation repository 128. Advantageously, the validation repository 128 provides a mechanism for the sender device 102 to publish verification information regarding the communication channel between the sender device 102 and the receiver device 116.
Example 10 includes the features of Example 9. In this example, the receiver device 116 is configured to determine an integrity of a communication channel between the sender device 102 and the receiver device 116 based on comparing the subset of sender binary values 132 to receiver binary values of a plurality of receiver qubits 123 corresponding to the validation qubit identifiers 130. Advantageously, the validation repository 128 is accessible to both the sender device 102 and the receiver device 116, thereby providing the receiver device 116 a mechanism to verify the integrity of the communication channel by confirming if the subset of sender binary values 132 are opposite receiver binary values of a subset of the plurality of receiver qubits 123 corresponding to the validation qubit identifiers 130.
Example 11 includes the features of any one of Examples 6 to 10. In this example, the method is executed by the sender device 102 based on secure data transmission code 646 downloaded to the sender device 102 from a remote data processing system, and where the method further comprises metering usage of the secure data transmission code 646, and generating an invoice based on metering the usage of the secure data transmission code 646. Advantageously, Example 11 enables aspects of the present disclosure to be delivered as a service for on-demand secure data transmission.
Example 12 is a computer-implemented method. The method includes receiving, at a receiver device 116, a securely transmittable value 108 from a sender device 102 associated with a first qubit 112, where the securely transmittable value 108 is configured to securely convey a data bit 104 from the sender device 102 to the receiver device 116. The method further includes generating a receiver binary value 126 by measuring a second qubit 124 that is entangled with the first qubit 112. The method further includes generating the data bit 104 by supplying the securely transmittable value 108 and the receiver binary value 126 to an XNOR gate 118.

Advantageously, Example 12 provides a mechanism to securely transmit data using entangled qubits. More specifically, Example 12 provides a mechanism for secure data transmission that does not rely on encryption. By not relying on encryption, Example 12 is resilient to quantum-based decryption attacks. Instead, Example 12 relies on communicating information that is not, itself, the transmitted data while nonetheless enabling the deciphering of the transmitted data using the phenomenon of entanglement between two qubits.
Example 13 includes the features of Example 12. In this example, the receiver binary value 126 is an opposite of a sender binary value 114 associated with the first qubit 112. Advantageously, the physics of entanglement can be used to ensure the sender binary value 114 is consistently opposite the receiver binary value 126, thereby creating a secure backchannel by which to transmit information enabling deciphering of the securely transmittable value 108 by the receiver device 116.
Example 14 includes the features of Example 13. In this example, the securely transmittable value 108 is generated by supplying the sender binary value 114 and the data bit 104 to an XOR gate 106. Advantageously, utilizing the sender binary value 114 and the XOR gate 106, coupled with the receiver binary value 126 and the XNOR gate 118, enables the data bit 104 to be securely and accurately transmitted between the sender device 102 and the receiver device 116.
Example 15 includes the features of any one of Examples 13 to 14. In this example, the method further includes retrieving, by the receiver device 116, validation qubit identifiers 130 and a subset of sender binary values 132 from a validation repository 128. The method further includes verifying an integrity of a communication channel between the sender device 102 and the receiver device 116 based on comparing the subset of sender binary values 132 to receiver binary values of a subset of a plurality of receiver qubits 123 corresponding to the validation qubit identifiers 130. Advantageously, the validation repository 128 provides a mechanism to verify an integrity of the communication channel between the sender device 102 and the receiver device 116 by confirming if the subset of sender binary values 132 is opposite the receiver binary values of the subset of the plurality of plurality of receiver qubits 123 corresponding to the validation qubit identifiers 130.
Example 16 includes the features of any one of Examples 12 to 15. In this example, the method is executed by the receiver device 116 based on secure data transmission code 646 downloaded to the receiver device 116 from a remote data processing system, and where the method further comprises metering usage of the secure data transmission code 646, and generating an invoice based on metering the usage of the secure data transmission code 646. Advantageously, Example 16 enables aspects of the present disclosure to be delivered as a service for on-demand secure data transmission.
Example 17 is a computer program product. The computer program product comprises one or more computer readable storage media, and program instructions collectively stored on the one or more computer readable storage media, the program instructions comprising instructions configured to cause one or more processors to perform a method according to any one of Examples 6 to 16. Likewise, Example 17 can realize any of the advantages discussed above with respect to Examples 6 to 16.
Example 18 is a system. The system includes one or more processors and one or more computer readable storage media collectively storing program instructions. The program instructions are configured to cause the one or more processors to perform a method according to any one of Examples 6 to 16. Likewise, Example 18 can realize any of the advantages discussed above with respect to Examples 6 to 16.

In view of the foregoing examples, a variety of technical use cases incorporating aspects of the present disclosure are contemplated. For example, aspects of the present disclosure can be utilized to securely transmit a one-time password (OTP) (e.g., data bit 104) from a server of a financial institution (e.g., sender device 102) to a smartphone of a client of the financial institution (e.g., receiver device 116) to authorize a transaction (e.g., transfer, payment, etc.). In this way, the OTP can be secure from eavesdropper attacks intercepting the OTP on the network 120 insofar as the OTP can be conveyed as a securely transmittable value 108.

In another example technical use case, personally identifiable information (PII), sensitive personal information (SPI), and/or other confidential or private data (e.g., data bit 104) can be securely transmitted between two parties. For example, a company or government institution can host an enrollment page on a web server (e.g., receiver device 116). A user can enroll in a service of the company or government institution by providing PII and/or SPI in the enrollment page from a desktop computer (e.g., sender device 102). The PII and/or SPI can be securely transmitted from the user's desktop computer to the web server using a securely transmittable value 108. In this way, PII and/or SPI can be protected from eavesdropper attacks and/or steal-now, decrypt-later attacks.

In another example technical use case, aspects of the present disclosure can be related to critical command-and-control operations. For example, aspects of the present disclosure can be used to securely convey remote instructions (e.g., data bit 104) from a command-and-control center (e.g., sender device 102) to critical endpoints hardened against cyberattacks (e.g., receiver device 116) such as satellites, remotely controlled vehicles (aerial, land, or sea-based), power generation plants, distribution grids, distribution pipelines, industrial plants, and the like. In this way, aspects of the present disclosure can be used to transmit data using securely transmittable values 108 to critical endpoints that could be the focal point of cyberattacks.

The aforementioned use cases are but three examples of many use cases that can incorporate aspects of the present disclosure. These use cases can be in fields as diverse as authentication management, identity management, confidential video-conferencing, secure messaging, transaction processing, and others.

As previously discussed, encryption has traditionally been used to securely transmit data. However, the advent of quantum computing poses a risk to the security of encrypted data. More specifically, the future development of quantum computing is likely to lead to the ability to decrypt encrypted data in relatively short periods of time. As a result, data encrypted using traditional encryption algorithms is at risk for steal-now, decrypt-later attacks. Steal-now, decrypt-later attacks collect and store encrypted data (e.g., network traffic) with the knowledge that the collected data cannot currently be decrypted, but that the collected data will likely be able to decrypted it in the future using quantum computing.

Collectively, and in view of the above Examples and technical use cases, aspects of the present disclosure provide a mechanism for secure data transmission without the use of encryption and the keys associated with encryption. Instead, aspects of the present disclosure utilize entangled qubits to securely transmit the information. The secure data transmission can occur over any channel, whether public or private, as the transmitted information does not, itself, reveal anything about the data being conveyed from the sender to the receiver.

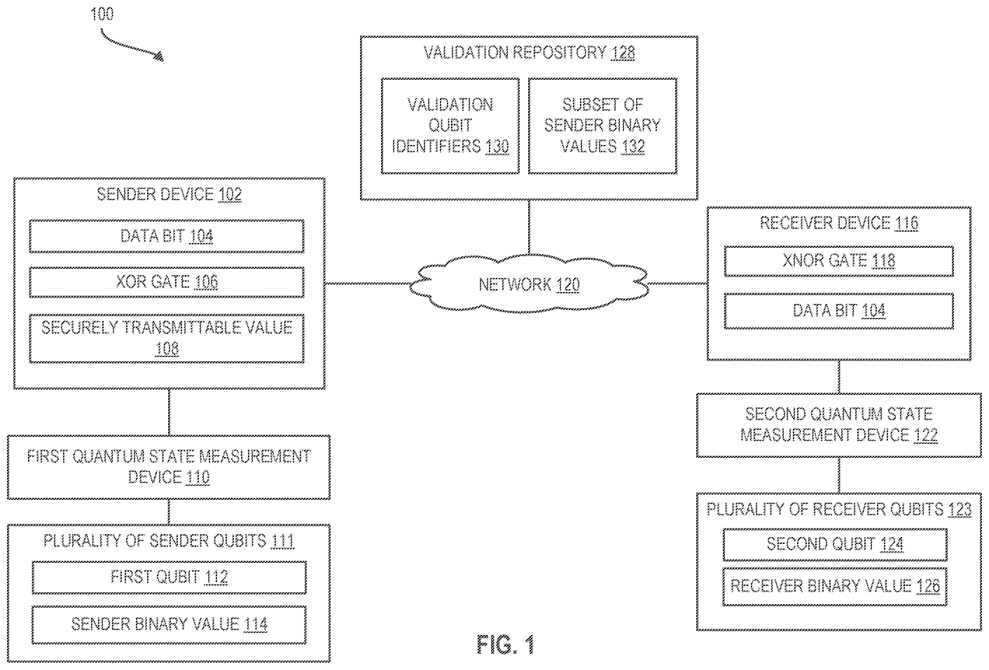

Referring now to the figures, FIG. 1 illustrates a block diagram of an example system 100 for secure data transmission using entangled qubits, in accordance with some embodiments of the present disclosure. The system 100 includes a sender device 102 configured to transmit data to a receiver device 116. The sender device 102 and receiver device 116 can be any electronic devices suitable for sending and receiving data such as, but not limited to, computers, desktops, laptops, tablets, smartphones, servers, mainframes, and/or other configurations of hardware and/or software. The sender device 102 and the receiver device 116 can be discrete physical entities or virtualized entities with underlying resources combined from disperse geographies and/or vendors.

The sender device 102 includes a data bit 104 for transmission. Data bit 104 is a binary value (e.g., 0 or 1). Data bit 104 can be a portion of a text file, video file, audio file, and/or other type of message for secure transmission from the sender device 102 to the receiver device 116.

Sender device 102 further includes an XOR gate 106. XOR gate 106 refers to an Exclusive OR logic gate (sometimes referred to as an EOR or EXOR gate). XOR gate 106 can receive two binary values and provide a true output (e.g., 1) when one and only one input is true (e.g., [1, 0] or [0, 1]) and provides a false output (e.g., 0) when both inputs are true or both inputs are false (e.g., [0, 0] or [1, 1]). XOR gate 106 can be implemented using, for example, metal-oxide-semiconductor field effect transistor (MOSFET) circuits, complementary metal-oxide-semiconductors (CMOS), transmission gates (e.g., with pass transistor logic (PTL)), using pass-gate-logic wiring, and the like. Additionally, XOR gate 106 can be constructed using combinations of other gates (e.g., an Exclusive Not OR (XNOR) gate followed by a NOT gate, multiple NOT-AND (NAND) gates, multiple NOR gates, etc.).

Sender device 102 further includes a securely transmittable value 108 that is created by combining the data bit 104 and a sender binary value 114 in the XOR gate 106. The sender binary value 114 is created by using a first quantum state measurement device 110 to measure a first qubit 112. The first qubit 112 is associated with the sender device 102, and the first qubit 112 is entangled with a second qubit 124 associated with the receiver device 116. The first qubit 112 and the second qubit 124 can be, for example, electrons, photons, positrons, and/or other particles having measurable quantum state information. For example, in the case of an electron, the measurable quantum state information can be related to a spin of the electron (e.g., spin up and spin down). In the case of a photon, the measurable quantum state information can be related to a polarization of the photon (e.g., vertical polarization and horizontal polarization).

As previously discussed, the first qubit 112 is entangled with the second qubit 124. Quantum entanglement is a phenomenon whereby two or more particles interact in such a way that the quantum state of each particle cannot be described independent of the state of the others, even if the two or more particles are separated by large distances. When the first quantum state measurement device 110 measures the first qubit 112, the first qubit 112 collapses from a state of superposition to a sender binary value 114 (e.g., a classical binary bit with a probabilistic value randomly distributed between 0 and 1). In doing so, the second qubit 124 also collapses from a state of superposition to a receiver binary value 126 that is opposite the sender binary value 114 due to the entangled nature of the first qubit 112 and the second qubit 124.

Although the present disclosure is primarily described using the example of data bit 104, first qubit 112, and second qubit 124, aspects of the present disclosure are likewise applicable to multiple of any of the aforementioned components, thereby enabling the secure transmission of multi-bit, byte, multi-byte, kilobyte (KB), megabyte (MB), gigabyte (GB) or larger messages, files, videos, audio, and the like. For example, data bit 104 can be but one of many (e.g., hundreds, thousands, or millions) bits of data that are transmitted between sender device 102 and receiver device 116. Further, the first qubit 112 can be but one of a plurality of sender qubits 111, where the plurality of sender qubits 111 can be respectively entangled with a plurality of receiver qubits 123 (including second qubit 124), thereby enabling multiple data bits to be securely and rapidly transmitted from sender device 102 to receiver device 116. However, regardless of the overall size of data to be transmitted by sender device 102, the data can be decomposed into binary bits and each bit securely transmitted to the receiver device 116 using aspects of the present disclosure.

The first quantum state measurement device 110 used to measure the first qubit 112 and the second quantum state measurement device 122 used to measure the second qubit 124 can be any quantum state measurement devices, methods, techniques, and/or protocols, now known or later developed. For example, the first quantum state measurement device 110 and/or the second quantum state measurement device 122 can utilize spectral lines, photographic film darkening, scintillation observations, cloud chambers, Geiger counters, interferometers, lasers, single-photon detectors, single-photon avalanche diodes, resonators, and/or other devices, machines, systems, and/or techniques useful for collapsing, through measurement, a superposition state of a qubit to a classical binary state. In some embodiments, there is only one quantum state measurement device that measures both the first qubit 112 and the second qubit 124.

Referring back to the securely transmittable value 108, it is an output of the XOR gate 106 when the XOR gate 106 is provided the data bit 104 and the sender binary value 114. Accordingly, the securely transmittable value 108 is a binary value. Further, the securely transmittable value 108 does not, itself, contain the data bit 104. In this way, the securely transmittable value 108 is resilient to steal-now, decrypt-later attacks.

The sender device 102 can transmit the securely transmittable value 108 to the receiver device 116 via a network 120. The network 120 can be a public and/or unsecured network. In other words, aspects of the present disclosure are robust against eavesdropper attacks that may occur on public and/or unsecured networks.

The receiver device 116 can receive the securely transmittable value 108 and supply it to an Exclusive NOR (XNOR) gate 118 together with the receiver binary value 126 to generate, as output from the XNOR gate 118, the data bit 104. The XNOR gate 118 can be otherwise referred to as an ENOR, EXNOR, or NXOR gate. The XNOR gate 118 can be fabricated similarly to the XOR gate 106 as described above. The XNOR gate 118 can generate a true value (e.g., 1) when both inputs are the same (e.g., [1, 1] or [0, 0]) and a false value (e.g., 0) when the inputs are not the same (e.g., [1, 0] or [0, 1]).

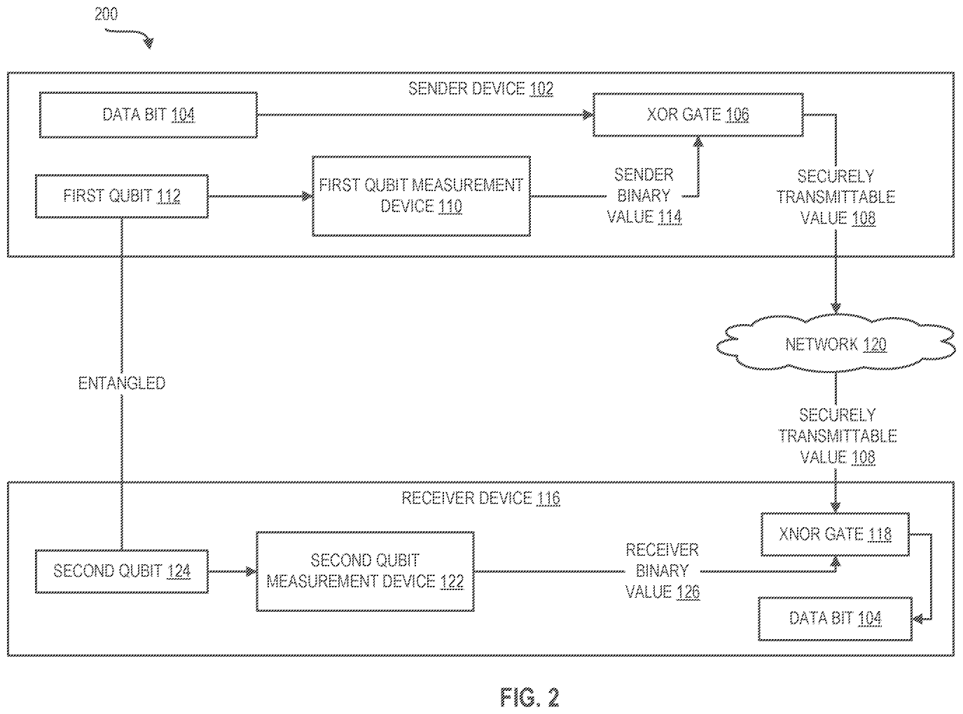

Insofar as the sender binary value 114 is opposite the receiver binary value 126 (by virtue of the phenomenon of quantum entanglement) and the XOR gate 106 is the logical opposite of the XNOR gate 118, the XNOR gate 118 is able to derive the data bit 104 from inputs of the securely transmittable value 108 and the receiver binary value 126. The various combinations of values are discussed in further detail hereinafter with FIG. 2.

In some embodiments, the system 100 further includes a validation repository 128 enabling the sender device 102 and receiver device 116 to validate an integrity of the communication channel realized by the secure data transmission protocol between the sender device 102 and the receiver device 116. The validation repository 128 can be a computational system capable of storing data accessible by two or more devices. In some embodiments, the validation repository 128 is a cloud-based storage repository. In some embodiments, the validation repository 128 is a blockchain network. The validation repository 128 can be publicly accessible to ensure the sender device 102 and the receiver device 116 can both access the validation repository 128 when establishing the secure data transmission protocol.

The validation repository 128 can include validation qubit identifiers 130. Validation qubit identifiers 130 can identify a subset of the plurality of sender qubits 111 used for validation purposes. The validation qubit identifiers 130 can identify the subset of the plurality of sender qubits 111 by position. For example, the validation qubit identifiers 130 can include an identification of positions (e.g., [1, 6, 7, 13]) to indicate that the subset of sender binary values 132 correspond to measurements of the qubits in the indicated positions of the plurality of sender qubits 111 (e.g., first, sixth, seventh, and thirteenth qubits of the plurality of sender qubits 111). The subset of sender binary values 132 are binary values derived by measuring qubits of the plurality of sender qubits 111 identified by the validation qubit identifiers 130. For example, the subset of sender binary values 132 can be [0, 1, 1, 0]. Further, the sender device 102 can publish the validation qubit identifiers 130 and the subset of sender binary values 132 to the validation repository 128.

Subsequently, the receiver device 116 can retrieve the validation qubit identifiers 130 and the subset of sender binary values 132 from the validation repository 128. Continuing the above example, the receiver device 116 can retrieve the validation qubit identifiers 130 (e.g., [1, 6, 7, 13]) and the subset of sender binary values 132 (e.g., [0, 1, 1, 0]). The receiver device 116 can measure qubits of the plurality of receiver qubits 123 corresponding to the validation qubit identifiers 130 (e.g., qubits of the plurality of receiver qubits 123 in positions [1, 6, 7, 13]). The receiver device 116 can then compare the measured qubits of the plurality of receiver qubits 123 to the subset of sender binary values 132 (e.g., [0, 1, 1, 0]). If the measurements are opposite (e.g., the subset of sender binary values 132 is [0, 1, 1, 0] and the measured qubits of the plurality of receiver qubits 123 is [1, 0, 0, 1]), then the sender device 102 and the receiver device 116 can validate the integrity of the secure data transmission protocol insofar as opposite values are expected to be generated as a result of entanglement between corresponding pairs of qubits. If validated, the sender device 102 can proceed to generate one or more securely transmittable values 108 and transmit them to the receiver device 116 as discussed in the present disclosure.

If the measurements are not opposite, then the secure data transmission protocol can be invalidated. If invalidated, the plurality of sender qubits 111 and the plurality of receiver qubits 123 can be discarded, and the sender device 102 and the receiver device 116 can re-establish the secure data transmission protocol using a new set of pairs of entangled qubits. An invalidated secure data transmission protocol can indicate, for example, transmission errors, technical errors, a malicious attack that altered the quantum state of the shared qubits, and/or a malicious attack that exchanged one shared qubit with a different shared qubit. Accordingly, the validation repository 128 can enable improved security and/or accuracy of the secure data transmission protocol discussed herein.

FIG. 2 illustrates a data flow diagram 200 within a system for secure data transmission using entangled qubits, in accordance with some embodiments of the present disclosure. The data flow diagram 200 includes features consistent with FIG. 1. As shown in FIG. 2, the sender device 102 includes a data bit 104 for transmission to a receiver device 116. The data bit 104 is provided to an XOR gate 106. The XOR gate 106 also receives a sender binary value 114. The sender binary value 114 is derived by a first quantum state measurement device 110 that measures a first qubit 112 (associated with the sender device 102) that is entangled with a second qubit 124 (associated with the receiver device 116). The XOR gate 106 outputs a securely transmittable value 108.

The sender device 102 transmits the securely transmittable value 108 to the receiver device 116 via a network 120. The receiver device 116 inputs the securely transmittable value 108 to an XNOR gate 118. The XNOR gate 118 receives as additional input a receiver binary value 126. The receiver binary value 126 is derived by a second quantum state measurement device 122 measuring the second qubit 124. In some embodiments, the second qubit 124 is measured within a threshold period of time following the measurement of the first qubit 112. In some embodiments, the second qubit 124 is measured upon receipt of the securely transmittable value 108 by the receiver device 116. The output of the XNOR gate 118 is the data bit 104.

Accordingly, there are four cases for the data flow diagram 200. Case 1: the data bit 104 is 0, and the first qubit 112 collapses to 0 when measured. In this case, the XOR gate 106 is provided [0, 0] and outputs 0. Therefore, the securely transmittable value 108 is 0. Thus, 0 is transmitted to the receiver device 116. The second quantum state measurement device 122 measures the second qubit 124. In this case, the second qubit 124 collapses to 1 when measured as a result of its entanglement with the first qubit 112. Accordingly, the XNOR gate 118 is provided [0, 1] and outputs 0 (i.e., the data bit 104).
Case 2: the data bit 104 is 0, and the first qubit 112 collapses to 1 when measured. In this case, the XOR gate 106 is provided [0, 1] and outputs 1. Therefore, the securely transmittable value 108 is 1. Thus, 1 is transmitted to the receiver device 116. The second quantum state measurement device 122 measures the second qubit 124. In this case, the second qubit 124 collapses to 0 when measured as a result of its entanglement with the first qubit 112. Accordingly, the XNOR gate 118 is provided [1, 0] and outputs 0 (i.e., the data bit 104).
Case 3: the data bit 104 is 1, and the first qubit 112 collapses to 0 when measured. In this case, the XOR gate 106 is provided [1, 0] and outputs 1. Therefore, the securely transmittable value 108 is 1. Thus, 1 is transmitted to the receiver device 116. The second quantum state measurement device 122 measures the second qubit 124. In this case, the second qubit 124 collapses to 1 when measured as a result of its entanglement with the first qubit 112. Accordingly, the XNOR gate 118 is provided [1, 1] and outputs 1 (i.e., the data bit 104).
Case 4: the data bit 104 is 1, and the first qubit 112 collapses to 1 when measured. In this case, the XOR gate 106 is provided [1, 1] and outputs 0. Therefore, the securely transmittable value 108 is 0. Thus, 0 is transmitted to the receiver device 116. The second quantum state measurement device 122 measures the second qubit 124. In this case, the second qubit 124 collapses to 0 when measured as a result of its entanglement with the first qubit 112. Accordingly, the XNOR gate 118 is provided [0, 0] and outputs 1 (i.e., the data bit 104).

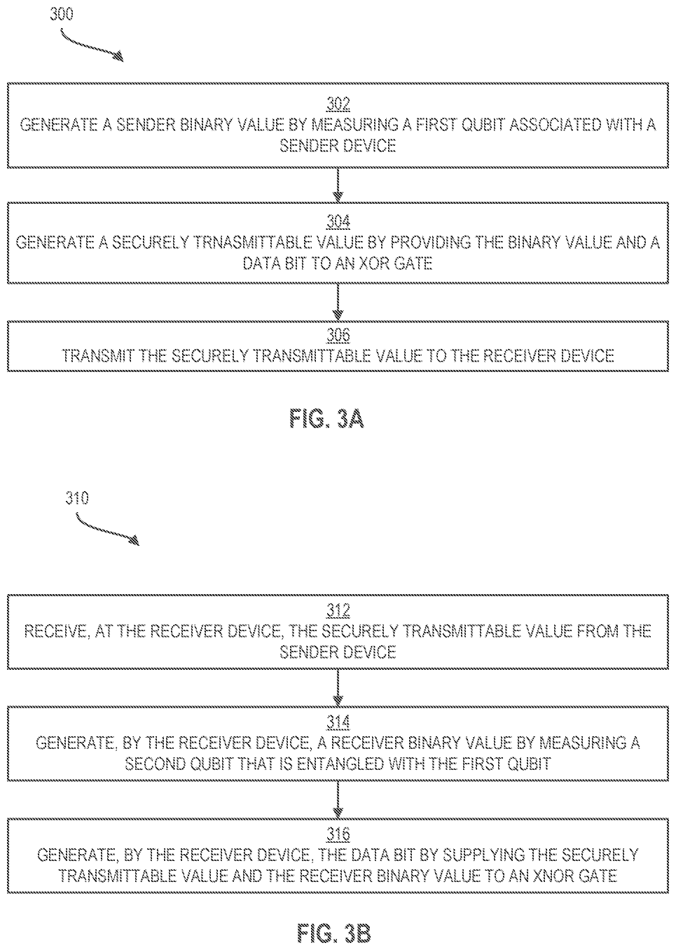

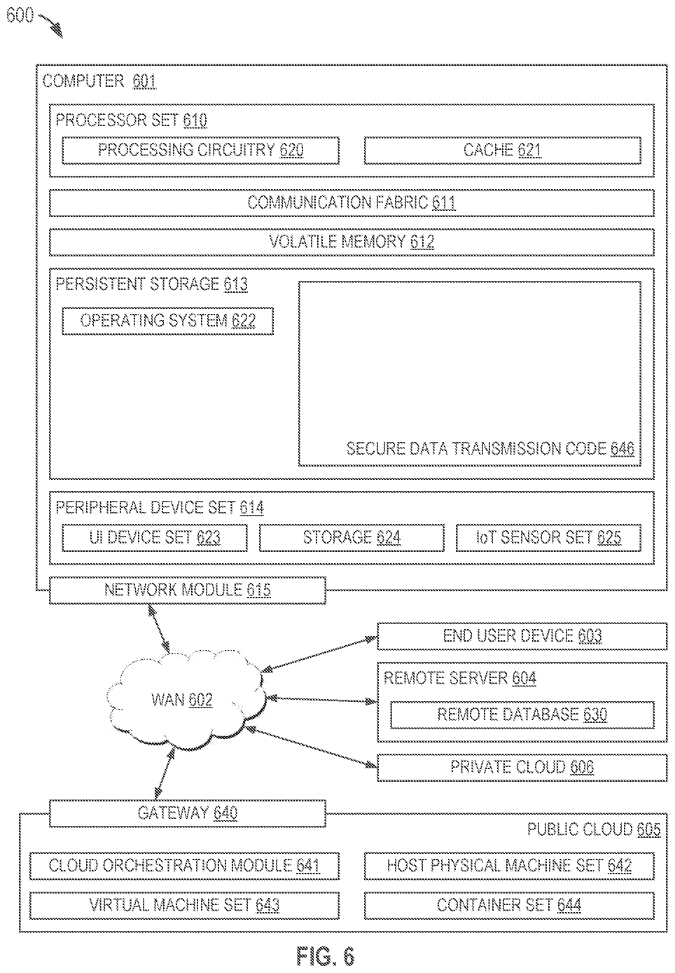

FIG. 3A illustrates a flowchart of an example method 300 for secure data transmission using entangled qubits at a sender device 102, in accordance with some embodiments of the present disclosure. In some embodiments, the method 300 can be implemented by a device (e.g., sender device 102 of FIG. 1), a computer (e.g., computer 601 of FIG. 6), one or more processors, and/or another configuration of hardware and/or software.

Operation 302 includes generating a sender binary value 114 by measuring a first qubit 112 associated with a sender device 102. In some embodiments, the first qubit 112 is measured by a first quantum state measurement device 110. In some embodiments, the first qubit 112 is entangled with a second qubit 124 associated with a receiver device 116.

Operation 304 includes generating a securely transmittable value 108 by providing the sender binary value 114 and a data bit 104 to an XOR gate 106. Operation 306 includes transmitting the securely transmittable value 108 to the receiver device 116 via a network 120.

FIG. 3B illustrates a flowchart of an example method 310 for secure data transmission using entangled qubits at a receiver device 116, in accordance with some embodiments of the present disclosure. In some embodiments, the method 300 can be implemented by a device (e.g., receiver device 116 of FIG. 1), a computer (e.g., computer 601 of FIG. 6), one or more processors, and/or another configuration of hardware and/or software. In some embodiments, the method 310 occurs after the method 300 of FIG. 3A.

Operation 312 includes receiving, at the receiver device 116, the securely transmittable value 108 from the sender device 102. The securely transmittable value 108 can be received via the network 120.

Operation 314 includes generating, by the receiver device 116, a receiver binary value 126 by measuring a second qubit 124 that is entangled with the first qubit 112. In some embodiments, the receiver binary value 126 is measured by a second quantum state measurement device 122. In some embodiments, the second qubit 124 is measured in response to receiving the securely transmittable value 108. In this way, aspects of the present disclosure can ensure the entangled qubits are each measured within a threshold amount of time.

Operation 316 includes generating, by the receiver device 116, the data bit 104 by supplying the securely transmittable value 108 and the receiver binary value 126 to an XNOR gate 118.

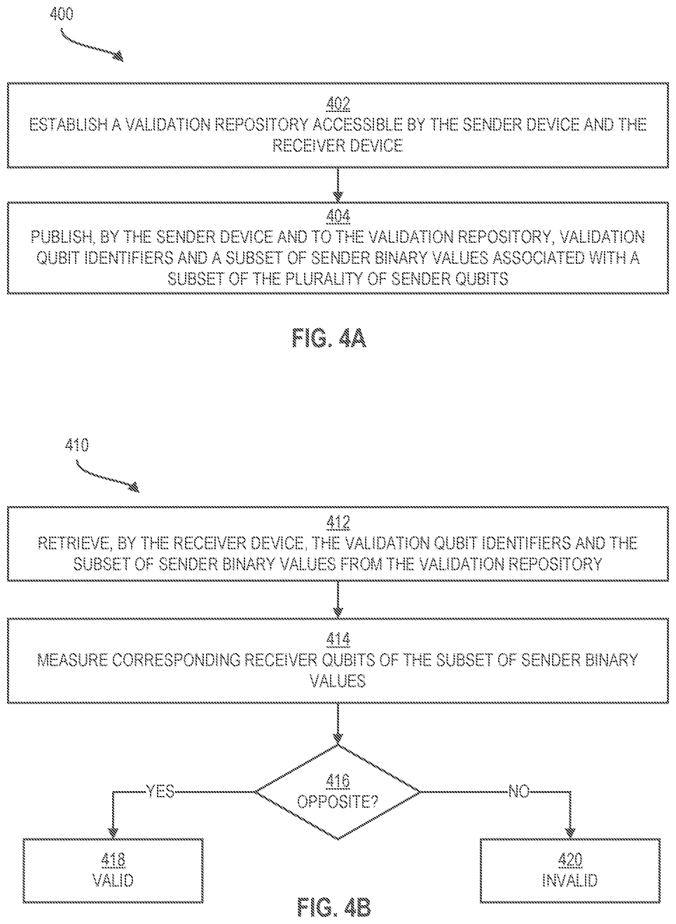

FIG. 4A illustrates a flowchart of an example method 400 for utilizing a validation repository 128 to publish validation qubit identifiers 130 and a subset of sender binary values 132 by a sender device 102, in accordance with some embodiments of the present disclosure. In some embodiments, the method 400 can be implemented by a device (e.g., sender device 102 of FIG. 1), a computer (e.g., computer 601 of FIG. 6), one or more processors, and/or another configuration of hardware and/or software. In some embodiments, the method 400 occurs before, during, or after the method 300 of FIG. 3A.

Operation 402 includes establishing a validation repository 128 accessible by the sender device 102 and the receiver device 116. In some embodiments, the location of the validation repository 128 is shared between the sender device 102 and the receiver device 116 as part of establishing the secure data transmission protocol between the sender device 102 and the receiver device 116 (e.g., when establishing one or more pairs of entangled qubits).

Operation 404 includes publishing, by the sender device 102 and to the validation repository 128, validation qubit identifiers 130 and a subset of sender binary values 132 associated with a subset of the plurality of sender qubits 111. In some embodiments, the validation qubit identifiers 130 include positional data indicating which qubits of the plurality of sender qubits 111 are measured in the subset of sender binary values 132. By publishing the validation qubit identifiers 130 and the subset of sender binary values 132 to the validation repository 128, the sender device 102 enables the receiver device 116 to verify the integrity of the secure data transmission protocol between the sender device 102 and the receiver device 116 (as discussed in more detail below with respect to FIG. 4B).

FIG. 4B illustrates a flowchart of an example method 410 for retrieving validation qubit identifiers 130 and the subset of sender binary values 132 from a validation repository 128 by a receiver device 116 to validate an integrity of a secure data transmission protocol, in accordance with some embodiments of the present disclosure. In some embodiments, the method 410 can be implemented by a device (e.g., receiver device 116 of FIG. 1), a computer (e.g., computer 601 of FIG. 6), one or more processors, and/or another configuration of hardware and/or software. In some embodiments, the method 410 occurs after the method 400 of FIG. 4A.

Operation 412 includes retrieving, by the receiver device 116, the validation qubit identifiers 130 and the subset of sender binary values 132 from the validation repository 128. In some embodiments, the receiver device 116 is notified of a location of the validation repository 128 when establishing the secure communication protocol between the sender device 102 and the receiver device 116.

Operation 414 includes measuring receiver qubits of the plurality of receiver qubits 123 corresponding to the subset of sender binary values 132. Operation 414 can rely on the positional information included in the validation qubit identifiers 130 to measure the correct receiver qubits of the plurality of receiver qubits 123. Operation 414 can measure the receiver qubits using the second quantum state measurement device 122.

Operation 416 includes determining whether the subset of sender binary values 132 is opposite the receiver binary values for corresponding receiver qubits measured in operation 414. The subset of sender binary values 132 is opposite the receiver binary values for corresponding receiver qubits if each pair of corresponding values contains non-matching binary numbers. In contrast, the subset of sender binary values 132 is not opposite the receiver binary values for corresponding receiver qubits if any pair of corresponding values contains matching binary numbers.

If so (416: YES), then the method 410 proceeds to operation 418 and determines that the secure data transmission protocol is valid. If valid, aspects of the present disclosure can proceed with transmitting data by generating and transmitting the securely transmittable value 108. If not (416: NO), then the method 410 proceeds to operation 420 and determines that the secure data transmission protocol is invalid. If invalid, aspects of the present disclosure can discard the plurality of sender qubits 111 and the plurality of receiver qubits 123 and re-establish the secure data communication protocol using new sets of qubits.

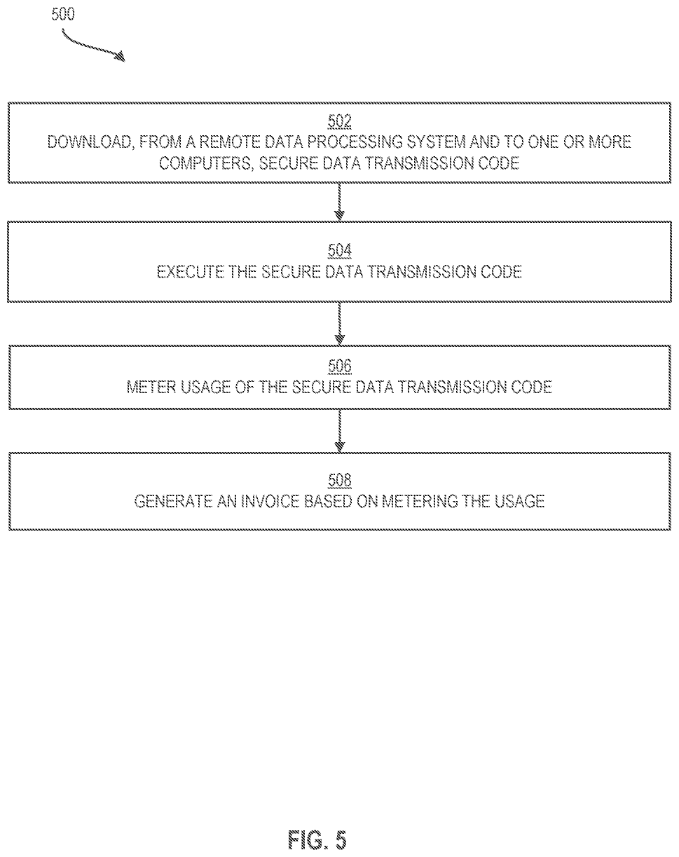

FIG. 5 illustrates a flowchart of an example method 500 for downloading, deploying, metering, and billing usage of secure data transmission code, in accordance with some embodiments of the present disclosure. The method 500 can be implemented by a device (e.g., sender device 102 and/or receiver device 116 of FIG. 1), a computer (e.g., computer 601 of FIG. 6), one or more processors, and/or another configuration of hardware and/or software. In some embodiments, the method 500 occurs contemporaneously with any of the aforementioned methods.

Operation 502 includes downloading, from a remote data processing system and to one or more computers (e.g., sender device 102, receiver device 116 of FIG. 1, computer 601 of FIG. 6, etc.) secure data transmission code (e.g., secure data transmission code 646 of FIG. 6). Operation 504 includes executing the secure data transmission code. The executing can include performing any of the methods and/or functionalities discussed herein. Operation 506 includes metering usage of the secure data transmission code. Usage can be metered by, for example, an amount of time the secure data transmission code is used, a number of servers, devices, and/or nodes deploying the secure data transmission code, an amount of resources consumed by implementing the secure data transmission code, an amount of data transmitted using the secure data transmission code, and/or other usage metering metrics. Operation 508 includes generating an invoice based on metering the usage.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 6 illustrates a block diagram of an example computing environment, in accordance with some embodiments of the present disclosure. Computing environment 600 contains an example of an environment for the execution of at least some of the computer code involved in performing the inventive methods, such as secure data transmission code 646. In addition to secure data transmission code 646, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and secure data transmission code 646, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in secure data transmission code 646 in persistent storage 613.

COMMUNICATION FABRIC 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in secure data transmission code 646 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

What is claimed is:

1. A system comprising:
a first quantum state measurement device configured to generate a sender binary value in response to measuring a first qubit;
a second quantum state measurement device configured to generate a receiver binary value in response to measuring a second qubit that is entangled with the first qubit;
a sender device configured to:
combine the sender binary value and a data bit in an XOR gate to generate a securely transmittable value; and
transmit the securely transmittable value to a receiver device; and
the receiver device that is configured to combine the receiver binary value and the securely transmittable value in an XNOR gate to generate the data bit.

2. The system of claim 1, wherein the sender binary value is opposite the receiver binary value.

3. The system of claim 1, wherein the sender binary value has a random probabilistic distribution between 0 and 1.

4. The system of claim 1, wherein the securely transmittable value does not contain the data bit.

5. The system of claim 1, further comprising:
a validation repository accessible by the sender device and the receiver device, wherein the validation repository stores validation qubit identifiers and a subset of sender binary values; and
wherein the receiver device is configured to compare the subset of sender binary values to receiver binary values of a subset of a plurality of receiver qubits with positions corresponding to the validation qubit identifiers to verify an integrity of a communication channel between the sender device and the receiver device.

6. A computer-implemented method comprising:
generating a sender binary value by measuring a first qubit associated with a sender device, wherein the first qubit is entangled with a second qubit associated with a receiver device; and
generating a securely transmittable value by providing the sender binary value and a data bit to an XOR gate, wherein the data bit is configured to be derived by the receiver device by supplying the securely transmittable value and a receiver binary value from the second qubit to an XNOR gate.

7. The computer-implemented method of claim 6, further comprising:
transmitting the securely transmittable value to the receiver device via a network.

8. The computer-implemented method of claim 6, wherein the receiver binary value is an opposite of the sender binary value.

9. The computer-implemented method of claim 6, further comprising:
publishing, by the sender device, validation qubit identifiers and a subset of sender binary values to a validation repository.

10. The computer-implemented method of claim 9, wherein the receiver device is configured to determine an integrity of a communication channel between the sender device and the receiver device based on comparing the subset of sender binary values to receiver binary values of a plurality of receiver qubits corresponding to the validation qubit identifiers.

11. The computer-implemented method of claim 6, wherein the computer-implemented method is executed by the sender device based on secure data transmission code downloaded to the sender device from a remote data processing system, and wherein the computer-implemented method further comprises:
metering usage of the secure data transmission code; and
generating an invoice based on metering the usage of the secure data transmission code.

12. A computer program product comprising one or more computer readable storage media, and program instructions collectively stored on the one or more computer readable storage media, the program instructions comprising instructions configured to cause one or more processors to perform a method comprising:
generating a sender binary value by measuring a first qubit associated with a sender device, wherein the first qubit is entangled with a second qubit associated with a receiver device; and
generating a securely transmittable value by providing the sender binary value and a data bit to an XOR gate, wherein the data bit is configured to be derived by the receiver device by supplying the securely transmittable value and a receiver binary value from the second qubit to an XNOR gate.

13. The computer program product of claim 12, further comprising additional program instructions configured to cause the one or more processors to perform the method further comprising:
transmitting the securely transmittable value to the receiver device via a network.

14. The computer program product of claim 12, wherein the receiver binary value is an opposite of the sender binary value.

15. The computer program product of claim 12, further comprising additional program instructions configured to cause the one or more processors to perform the method further comprising:
publishing, by the sender device, validation qubit identifiers and a subset of sender binary values to a validation repository.

16. The computer program product of claim 15, wherein the receiver device is configured to determine an integrity of a communication channel between the sender device and the receiver device based on comparing the subset of sender binary values to receiver binary values of a plurality of receiver qubits corresponding to the validation qubit identifiers.

17. A computer-implemented method comprising:
receiving, at a receiver device, a securely transmittable value from a sender device associated with a first qubit, wherein the securely transmittable value is configured to securely convey a data bit from the sender device to the receiver device;
generating a receiver binary value by measuring a second qubit that is entangled with the first qubit; and
generating the data bit by supplying the securely transmittable value and the receiver binary value to an XNOR gate.

18. The computer-implemented method of claim 17, wherein the receiver binary value is an opposite of a sender binary value associated with the first qubit.

19. The computer-implemented method of claim 18, wherein the securely transmittable value is generated by supplying the sender binary value and the data bit to an XOR gate.

20. The computer-implemented method of claim 18, further comprising:
retrieving, by the receiver device, validation qubit identifiers and a subset of sender binary values from a validation repository; and
verifying an integrity of a communication channel between the sender device and the receiver device based on comparing the subset of sender binary values to receiver binary values of a subset of a plurality of receiver qubits corresponding to the validation qubit identifiers.

21. The computer-implemented method of claim 17, wherein the computer-implemented method is executed by the receiver device based on secure data transmission code downloaded to the receiver device from a remote data processing system, and wherein the computer-implemented method further comprises:
metering usage of the secure data transmission code; and
generating an invoice based on metering the usage of the secure data transmission code.

22. A computer program product comprising one or more computer readable storage media, and program instructions collectively stored on the one or more computer readable storage media, the program instructions comprising instructions configured to cause one or more processors to perform a method comprising:
receiving, at a receiver device, a securely transmittable value from a sender device associated with a first qubit, wherein the securely transmittable value is configured to securely convey a data bit from the sender device to the receiver device;
generating a receiver binary value by measuring a second qubit that is entangled with the first qubit; and
generating the data bit by supplying the securely transmittable value and the receiver binary value to an XNOR gate.

23. The computer program product of claim 22, wherein the receiver binary value is an opposite of a sender binary value associated with the first qubit.

24. The computer program product of claim 23, wherein the securely transmittable value is generated by supplying the sender binary value and the data bit to an XOR gate.

25. The computer program product of claim 23, wherein the program instructions comprise additional instructions configured to cause the one or more processors to perform the method further comprising:
retrieving, by the receiver device, validation qubit identifiers and a subset of sender binary values from a validation repository; and
verifying an integrity of a communication channel between the sender device and the receiver device based on comparing the subset of sender binary values to receiver binary values of a subset of a plurality of receiver qubits corresponding to the validation qubit identifiers.
